(19) United States
(12) Patent Application Publication
(10) Pub. No.: US 2025/0145370 A1
(43) Pub. Date: May 8, 2025

(54) BLADE CONTAINER OPERABLE TO SEVER A BLADE

(71) Applicant: INDUSTRO INTERNATIONAL CO., LTD., Taichung City (TW)

(72) Inventor: KUO-CHAN HUANG, Taichung City (TW)

(21) Appl. No.: 18/387,434

(22) Filed: Nov. 6, 2023

(51) Int. Cl. B65F 1/16

(52) U.S. Cl. CPC B65F 1/1646; B65F 2240/116

(57) ABSTRACT

A blade container includes a box and a lid. The box includes a recycling chamber, a severing slit in communication with the recycling chamber, a storing chamber next to the recycling chamber, and an aperture in communication with the storing chamber and in parallel to the severing slit. The lid is attachable to the box, thereby closing the aperture and the severing slit.

### BACKGROUND OF INVENTION

### 1. Field of Invention

The present invention relates to a blade container and, more particularly, to a blade container operable to sever a blade.

### 2. RELATED PRIOR ART

A conventional utility cutter (or “box cutter”) includes a blade made with grooves in at least one side, thereby dividing the blade into sections. Each of the sections of the blade includes a tip for cutting paper, wood or any other proper thing. A leading one of the sections of the blade is severed from the remaining sections of the blade when its tip becomes blunt after some time of use.

CN 216071230 discloses a blade container including a box 1 and a cover 2. The box 1 includes a space 11 for containing blades 3. The cover 2 includes a section 21 insertable in the space 11 of the box 1 to keep the blades 3 in box 1. However, this blade container does include any element for severing the leading section of each of the blades 3 from the remaining sections of the same.

CN216574820 discloses a blade container including a box 1 and a cover 2. The box 1 includes a groove 3 in a lower end. A leading section of a blade is inserted in the groove 3 and the box 1 is operated to sever the leading section of the blade from the remaining sections of the blade. Each time a section is severed from the blade, the separated section of the blade must be immediately disposed of to prevent it from damaging anything or hurting anyone. However, such immediate disposal is sometimes inconvenient.

The present invention is therefore intended to obviate or at least alleviate the problems encountered in the prior art.

### SUMMARY OF INVENTION

It is the primary objective of the present invention to provide a convenient blade container.

To achieve the foregoing objective, the blade container includes a box and a lid. The box includes a recycling chamber, a severing slit in communication with the recycling chamber, a storing chamber next to the recycling chamber, and an aperture in communication with the storing chamber and in parallel to the severing slit. The lid is attachable to the box, thereby closing the aperture and the severing slit.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a blade container according to the first embodiment of the present invention;

FIG. 2 is an exploded view of the blade container shown in FIG. 1;

FIG. 3 is a partial view of the blade container shown in FIG. 1;

FIG. 4 is a perspective view of the blade container in another position than shown in FIG. 1;

FIG. 5 is a side view of the blade container shown in FIG. 3;

FIG. 6 is a perspective view of the blade container shown in FIG. 1 used with a hangable sheath assembly;

FIG. 7 is a side view of a blade container according to the second embodiment of the present invention; and

FIG. 8 is a side view of a blade container according to the third embodiment of the present invention.

### DETAILED DESCRIPTION OF EMBODIMENTS

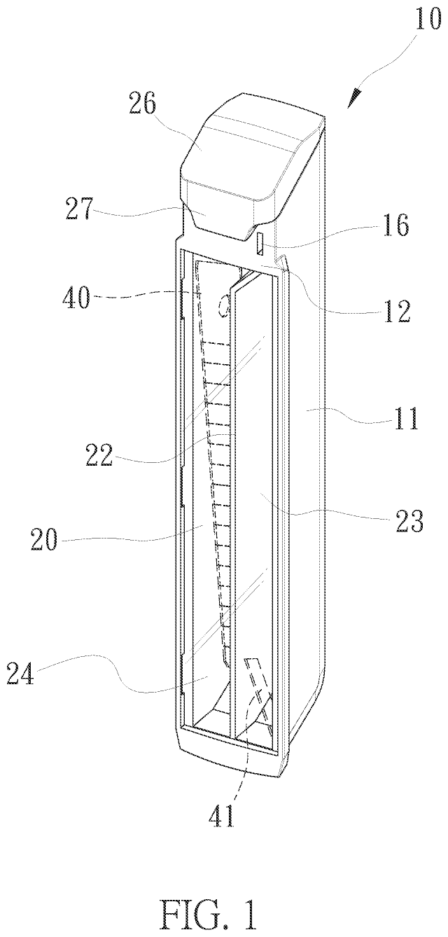

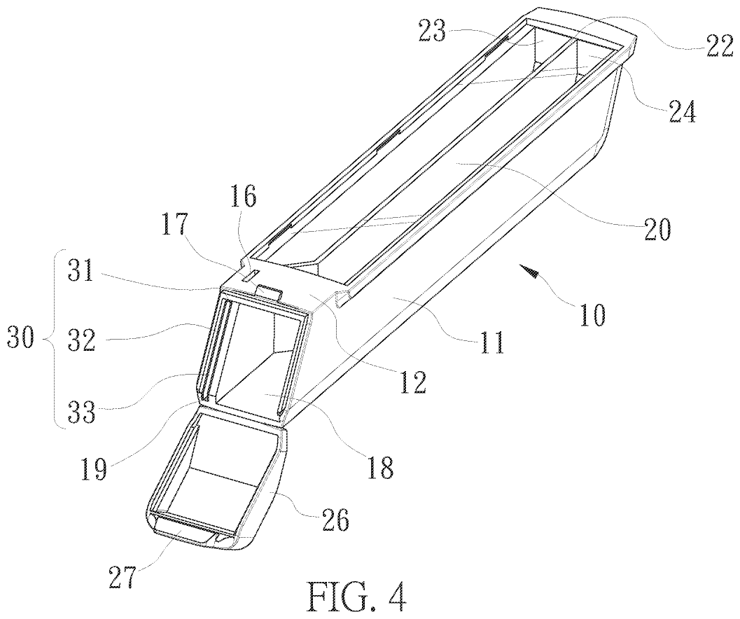

Referring to FIGS. 1, 2 and 4, a blade container 10 includes a box 11, a lid 26 and a lining 30 according to a first embodiment of the present invention. The box 11 includes a partition 22 that divides the interior of the box 11 into an aperture 18, a severing slit 19, a recycling chamber 23 and a storing chamber 24. The severing slit 19 gets wider as it extends toward the recycling chamber 23. The storing chamber 24 gets wider as it extends to the aperture 18. The partition 22 extends between the recycling chamber 23 and the storing chamber 24 so that the chambers 23 and 24 extend in parallel to each other. The recycling chamber 23 is as wide as the storing chamber 24. The partition 22 extends between the aperture 18 and the severing slit 19. The severing slit 19 is narrower than the recycling chamber 23. The aperture 18 is wider than the storing chamber 24. Thus, the aperture 18 allows a user to use a finger to take a blade 40 from the storing chamber 24 for operation or put the blade 40 into the storing chamber 24 for storage. The blade 40 is formed with weak points in the form of grooves that divide the blade 40 into sections 41 that can be severed from the blade 40 one after another.

The lining 30 includes a connective portion 31 extending between two plates 32. The lining 30 is inserted in the severing slit 19. The plates 32 together provide a narrow passageway 33 that is narrower than the severing slit 19. A blunt section 41 of a blade 40 is inserted in the narrow passageway 33 and severed from the blade 40 to allow use of a sharp section 41 of the blade 40. The severed section 41 of the blade 40 falls into the recycling chamber 23 from which the severed section 41 of the blade 40 can recycled. The plates 32 are operable to bend and sever the blunt section 41 from the blade 40. The plates 32 are harder than the box 11 to stand a torque for bending the blade 40.

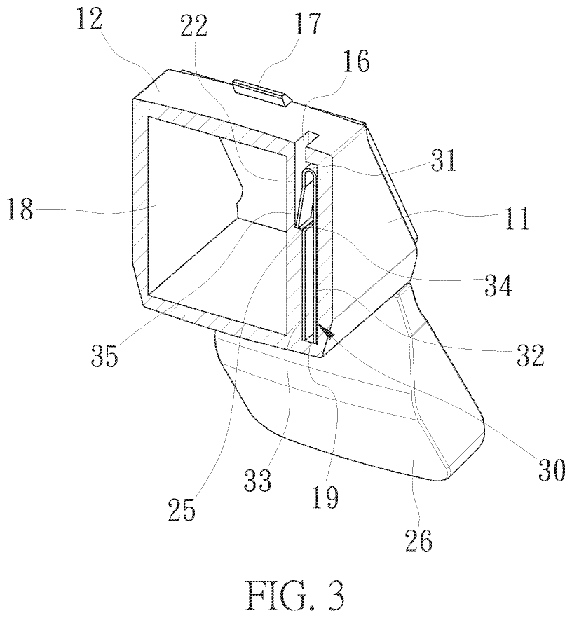

Referring to FIG. 3, the partition 22 includes a bore 25 in communication with the severing slit 19. A selected one of the plates 32 is cut with a recess 34, thereby turning a portion of the selected plate 32 into an elastic tab 35 extending from the remaining one of the plates 32. The elastic tab 35 extends into the bore 25 and abuts against an internal portion of the lid 26 so that the lining 30 cannot leave the lid 26 through the severing slit 19.

The box 11 includes a dismantling bore 16 in a front portion 12, a rear portion 50 and two lateral walls (not numbered). The dismantling bore 16 is in communication with the bore 25. Thus, a flat element such as a flat head of a screwdriver is insertable into the bore 25 via the dismantling bore 16 to render the elastic tab 35 coplanar with the selected plate 32. That is, the elastic tab 35 is disengaged from the internal portion of the lid 26 to allow the lining 30 to be moved from the lid 26 via the severing slit 19. The recycling chamber 23 includes a tapered portion extending toward the severing slit 19 to facilitate removing of each separated section 41 from the recycling chamber 23 via the severing slit 19.

Referring to FIGS. 1, 2 and 4, the front portion 12 includes a window 13 in communication with both the recycling chamber 23 and the storing chamber 24. The window 13 is located between the lateral walls of the box 11. A lens 20 is used to cover the window 13 to keep the blade 40 in the storing chamber 24 and keep the separated section(s) 41 in the recycling chamber 23. The user can see through the lens 20 and know how many blades 40 are in the storing chamber 24 to determine whether to add more blades 40 into the storing chamber 24. Moreover, the user can see through the lens 20 and how many separated sections 41 are in the recycling chamber 23 to determine whether to empty the recycling chamber 23.

To connect the lens 20 to the box 11, two groups of fins 21 and two groups of grooves 15 are used. Each of the groups of fins 21 extends from an edge of the lens 20 (or a corresponding one of the lateral walls of the box 11). Each of the groups of grooves 15 is made in a corresponding one of the lateral walls of the box 11 (or an edge of the lens 20). The fins 21 are inserted in the grooves 15, thereby connecting the lens 20 to the box 11. Preferably, each of the lateral walls of the box 11 is formed with a stepped portion 14 in which a group of grooves 15 is made.

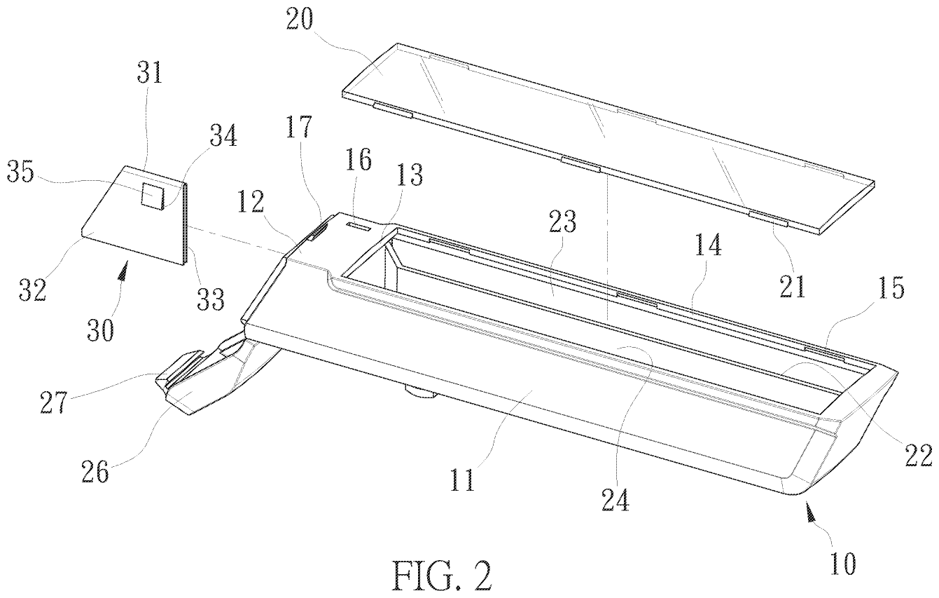

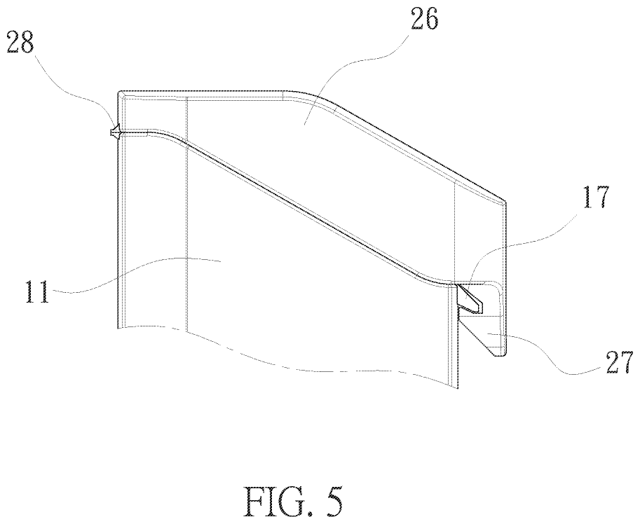

Referring to FIGS. 2, 4 and 5, flexible, elastic, foldable or bendable linking portion 28 is formed between the box 11 and the lid 26 to allow the lid 26 to be removed from the box 11 without the risks of being lost. The lid 26 is attachable to the box 11 to cover the aperture 18 and the severing slit 19. The lid 26 includes a hook 27 engageable with a wedge 17 formed on the front portion 12 of the box 11 to keep the lid 26 covering the box 11. The hook 27 can be disengaged from the wedge 17 to allow detachment of the lid 26 from the box 11.

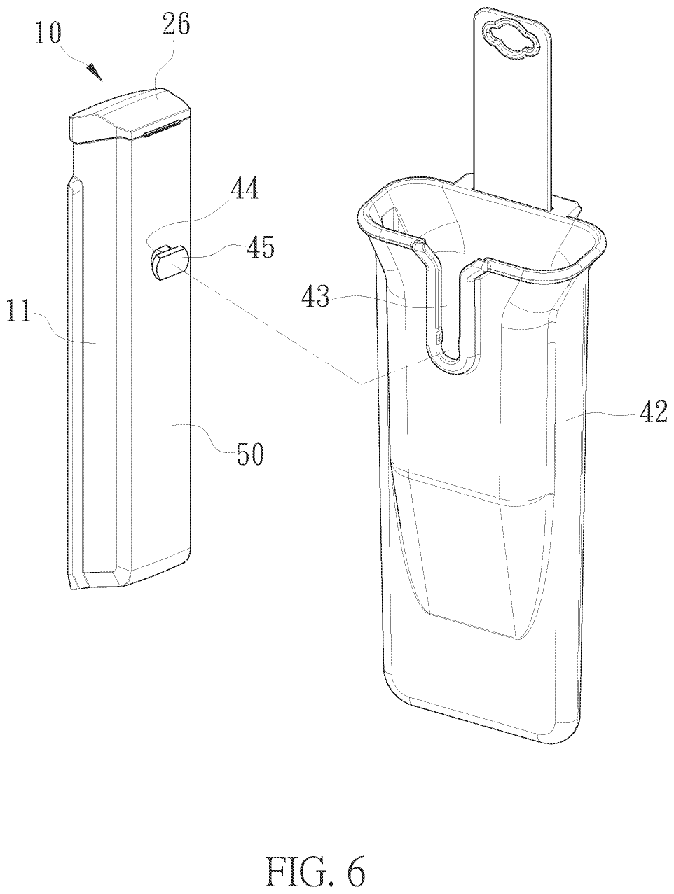

Referring to FIGS. 1 and 6, the box 11 includes a neck 44 on the rear portion 50 of the box 11 and a head 45 on the neck 44. Preferably, the neck 44 is a circular stem. Preferably, the head 45 is a substantially in rectangular flat portion with two ends extending beyond the neck 44. In another embodiment, the head 45 can however be a disc with a diameter larger than that of the neck 44.

The blade container 10 is engageable with a hangable sheath 42. The hangable sheath 42 includes a slit 43 for receiving the neck 44 so that the box 11 is smoothly movable into the hangable sheath 42. The head 45 is located out of the hangable sheath 42 while the box 11 is located in the hangable sheath 42. The blade container 10 can easily be moved from the hangable sheath 42 for use.

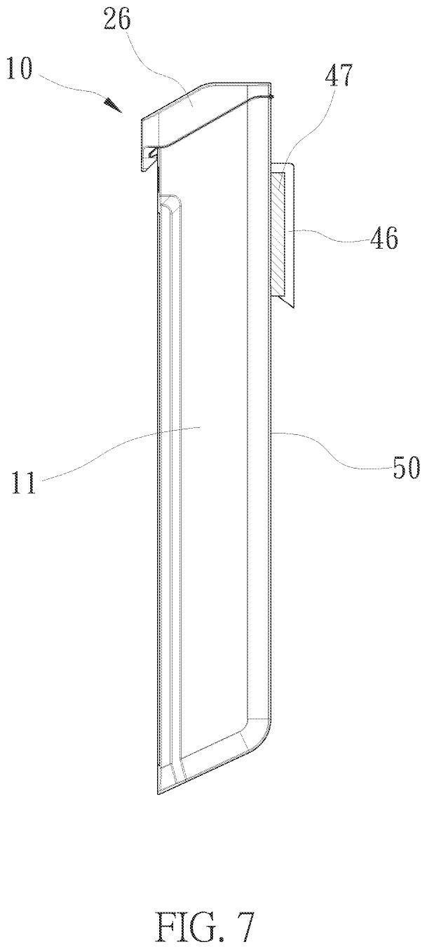

Referring to FIGS. 1 and 7, there is a blade container 10 according to a second embodiment of the present invention. The second embodiment is like the first embodiment except for including a clip 46 instead of the combination of the neck 44 with the head 45. The clip 46 is engageable with a belt 47 worn by the user so that the user easily carries the blade container 10. The blade container 10 is located on an external side of the belt 47 while the clip 46 is located on an internal side of the belt 47. The clip 46 is preferably shaped like a hook.

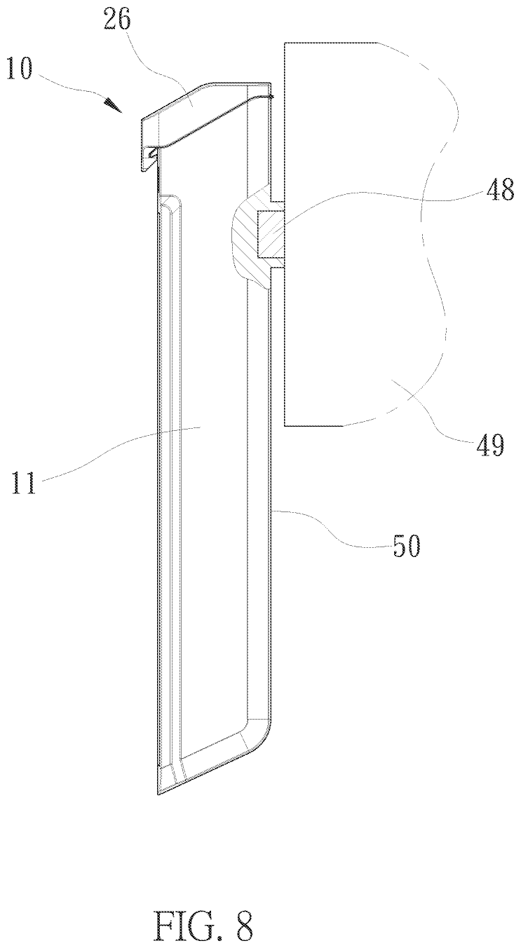

Referring to FIGS. 1 and 8, there is a blade container 10 according to a third embodiment of the present invention. The third embodiment is identical to the second embodiment except for including a magnet 48 instead of the clip 46. The magnet 48 magnetically attracts an accessory 49 that is ferromagnetic.

The present invention has been described via the illustration of the embodiments. Those skilled in the art can derive variations from the embodiments without departing from the scope of the present invention. Therefore, the embodiments shall not limit the scope of the present invention defined in the claims.

1. A blade container comprising:
a box comprising a recycling chamber, a severing slit in communication with the recycling chamber, a storing chamber next to the recycling chamber, and an aperture in communication with the storing chamber and in parallel to the severing slit; and
a lid attachable to the box, thereby closing the aperture and the severing slit.

2. The blade container according to claim 1, further comprising a lining located in the severing slit and formed with two plates extending on two opposite sides of the severing slit.

3. The blade container according to claim 2, wherein the box further comprises a partition between the recycling chamber and the storing chamber, wherein the partition extends so that the recycling chamber is tapered toward the severing slit and that the storing chamber expands toward the aperture.

4. The blade container according to claim 2, wherein the box further comprises a bore in communication with the severing slit, thereby forming a shoulder, wherein one of the plates of the lining comprises an elastic tab engageable with the shoulder so that the lining cannot leave the box through the severing slit.

5. The blade container according to claim 4, further comprising a dismantling bore in communication with the bore to allow a flat element to extend into the bore via the dismantling bore to pivot the elastic tab to allow movement of the lining from the bore via the severing slit.

6. The blade container according to claim 1, wherein the box further comprises a wedge, wherein the lid comprises a hook engageable with the wedge to keep the lid on the box.

7. The blade container according to claim 1, wherein the box further comprises:
a window in communication with the recycling chamber and the storing chamber; and
a lens for covering the window so that a user is allowed to see through the lens and look into the recycling chamber and the storing chamber.

8. The blade container according to claim 7, wherein the box further comprises two stepped portions on two opposite sides of the window and two groups of grooves, wherein each of the groups of grooves is made in a corresponding one of the stepped portions, wherein the lens comprises two groups of fins fitted in the groups of grooves.

9. The blade container according to claim 1, further comprising a linking portion formed between the box and the lid.

10. The blade container according to claim 1, further comprising a hangable sheath for receiving the box.

11. The blade container according to claim 10, wherein the box further comprises a neck on a rear portion and a head on the neck, wherein the head comprises portions extending beyond the neck wherein the hangable sheath comprises a slit for receiving the neck, wherein the head is located out of the hangable sheath while the box is located in the hangable sheath.

12. The blade container according to claim 1, further comprising a clip connected to the box and operable for engagement with a belt.

13. The blade container according to claim 1, further comprising a magnet connected to the box and operable for magnetically attracting a ferromagnetic accessory.
